(19) United States
(12) Patent Application Publication
(10) Pub. No.: US 2009/0250489 A1
(43) Pub. Date: Oct. 8, 2009

(54) Wine Container and Dispenser

(75) Inventors: Craig Saunders, Cleveland, OH (US); Rachel Nottingham, Cleveland, OH (US); Jens Johnson, Cleveland, OH (US)

Correspondence Address: PATENT, COPYRIGHT & TRADEMARK LAW GROUP, 4199 Kinross Lakes Parkway, Suite 275, RICHFIELD, OH, 44286, US

(73) Assignee: 585 Wine Partners, LLC

(21) Appl. No.: 12/418,361

(22) Filed: Apr. 3, 2009

Related U.S. Application Data
(60) Provisional application No. 61/042,826, filed on Apr. 7, 2008.

(51) Int. Cl. B65D 35/56; B65D 35/28; B65D 35/38; B67D 3/00

(52) U.S. Cl. 222/105; 222/1; 222/566

(57) ABSTRACT

An improved wine container and dispenser system is provided having a container that forms an overall, generally cylindrical housing exemplarily formed of a left barrel half or first cylindrical casing opposite a right barrel half or second cylindrical casing, and a front lid opposite a rear lid. A tray is positioned inside the container so that it slants toward the opening which accommodates the pour spout. The sloping profile of the tray facilitates in using the entire contents without having to tilt the wine container and dispenser system. An outer sheath circumscribes the assembled barrel body, and a spout, in fluid communication with an internally stored, compressible fluid bladder. This outer sheath is placed around the assembled container to provide two functions: to provide an indicia supporting surface to allow for placement of branding material, printed logo or advertisement, and can work in conjunction with the overall container to provide a unique brand differentiation; and, to provide an inwardly tensioned securing force to the assembled barrel halves to provide an overall rigidity to the assembly for handling, shipping, and packing. The spout is protected by a spout cover that is removably affixed to the front lid.

### RELATED APPLICATIONS

The present invention claims benefit of U.S. Provisional Application Ser. No. 61/042,826 filled on Apr. 7, 2008 and incorporated by reference herein as if fully rewritten.

### BACKGROUND OF THE INVENTION

1. Field of the Invention

The present invention relates generally to wine containers and dispensers and, more specifically, to an improved portable, bulk wine container and dispenser having differentiated packaging design.

2. Description of the Related Art

Portable fluid containers are well known in the art. They are generally used for storing, preserving, or transporting various types of fluids. Most consumer-oriented fluid containers are based on a cylindrical or polygonal prismatic shape to store the fluid therein. Although portable fluid containers are generally well adapted to consumer use, there are several known disadvantages with regards to containers used to store wine.

A particular problem with fluid containers used to store wine, or a similar beverage, is that they are not easily adaptable to the requirements of the particular contents, or the needs of the distribution channel in which they are sold. This is especially true with wine, in conventional containers are limited in the volume of wine they are capable of storing and their ease of storage, distribution and dispensing.

Usually, wine is either bottled in standard sized containers, or kept in air-tight barrels. If a consumer desires to purchase a quantity larger than a single bottle, but smaller than the industrially sized barrel, the only choice they have is purchasing a number of individual bottles. This is often cumbersome and ultimately leads to an increased consumer cost due to a need to purchase multiple bottles.

Additionally, conventional wine bottles and containers are subject to an undifferentiated design compared to similar consumer products. Generally, wine containers come in the form of a standard size bottle. Although the label and/or bottle packaging may be used to advertise the product, these means are generally ineffective since such product differentiation techniques are available to all manufacturers.

In the late 1960's there was the development of a box wine, also known in the industry as cask wine, bladder pack, goon, or “bag-in-a-box”. Such packages contain a plastic bladder protected by a box, usually made of corrugated cardboard. The strong bladder (or plastic bag), usually made of metalized film or other plastics, is seated inside the corrugated fiberboard box. The bag is filled by the manufacturer with the desired liquid and sealed. A plastic, air-tight tap is welded into the metalized bladder, making storage much more convenient for consumers. All modern wine casks now utilize some sort of plastic tap, which is exposed by tearing away a perforated panel on the box. In spite of some benefits of such a packaging system, such cask wines have developed a poor reputation.

This can come from a number of drawbacks that such systems.

If the plastic bladder or ‘bag’ is not hermetically sealed, or if the seal is compromised, the unopened shelf life shorter than bottled wine. In addition, the geometry of bosh boxes allow for placement in various orientations; this can also allow unknowing and unwanted intrusion of air into the bladder which allows for oxidation of the wine. Further still, most casks will have a best-before date stamped and, as a result, it is not intended for cellaring and should be consumed within the prescribed period. Deterioration may be quite noticeable by 12 months after filling due to migration of oxygen through the sealed bladder wall itself.

However, box wine is considered to have benefits from an environment protection point of view. The bag allows a contents of 3-10 liters, so that far less packaging mass is required. The packaging material itself can be made from is lightweight materials, which reduces greenhouse gas emissions caused by transport (as opposed to glass containers, which weigh much more). Further, the bag in a box packaging system can be inexpensive relative to other systems.

Although the prior art devices have a widely-accepted use, they nonetheless suffer from these drawbacks herein discussed. Prior art devices limit the consumer's choices to purchasing conventional wine bottles that are largely undifferentiated from competitor products. Often times, in spite of the propounded beneficial feature of being able to partially dispense wine over time without oxidation, this can prove to be un-achieved for many of the reasons cited above.

There is a need within the art for an improved portable wine container and dispenser having a differentiated packaging design that allows the contents to be easily kept and dispensed over time.

### SUMMARY OF THE INVENTION

The present invention provides for a portable fluid container adapted for storing and dispensing wine. While a preferred embodiment of the wine container and dispenser is described, the invention also provides embodiments wherein a multitude of packaging and display options are disclosed.

The wine container and dispenser described by this invention is such that it is easily and efficiently manufactured and is convenient for consumer-oriented retail.

Accordingly, it is an objective of the present invention to provide the art with a novel wine container and dispenser that eliminates the disadvantages associated with prior art wine containers.

Advantages of the present invention are that it provides and effective and efficient wine storage and dispensing system that can be packages, shipped, distributed and stored with a minimum of packaging material and maximum of volume efficiency.

Other advantages of the present invention are that it provides a convenient wine storage and dispensing system that is highly differentiated from existing competitive products. It is envisioned that the present invention is of simple construction that is easily adaptable to mass production.

These and other objects of the present invention will become more readily apparent from a reading of the following detailed description taken in conjunction with the accompanying drawings wherein like reference numerals indicate similar parts, and with further reference to the appended claims.

### BRIEF DESCRIPTION OF THE DRAWINGS

The advantages and features of the present invention will become better understood with reference to the following detailed description and claims taken in conjunction with the accompanying drawings in which like elements are identified with like symbols and in which:

FIG. 1 is a perspective view of an improved wine container and dispenser 10 according to a preferred embodiment of the present invention;

FIG. 2 is an exploded perspective view thereof;

FIG. 3a-3c are an internal elevation, front elevation, and perspective view, respectively, of a left barrel half 12, for use therein;

FIG. 4a-4c are an internal elevation, front elevation, and perspective view, respectively, of a right barrel half 14, for use therein;

FIG. 5a-5c are a perspective, front elevation, and side elevation view, respectively, of the front lid 16, for use therein;

FIG. 6a-6c are a perspective, front elevation, and side elevation view, respectively, of the rear lid 18, for use therein;

FIG. 7 is an exploded partial detail of a connection detail showing a tapered end at a rear portion 124 or front portion 126, for use therein;

FIG. 8 is an exploded partial detail of the connection of FIG. 7 attached to a front lid 16 or rear lid 18, for use therein; and

FIG. 9a-9c are perspective, front elevation, and side elevation view, respectively, of a spout cover 26 for use therein.

### DETAILED DESCRIPTION OF THE PREFERRED EMBODIMENTS

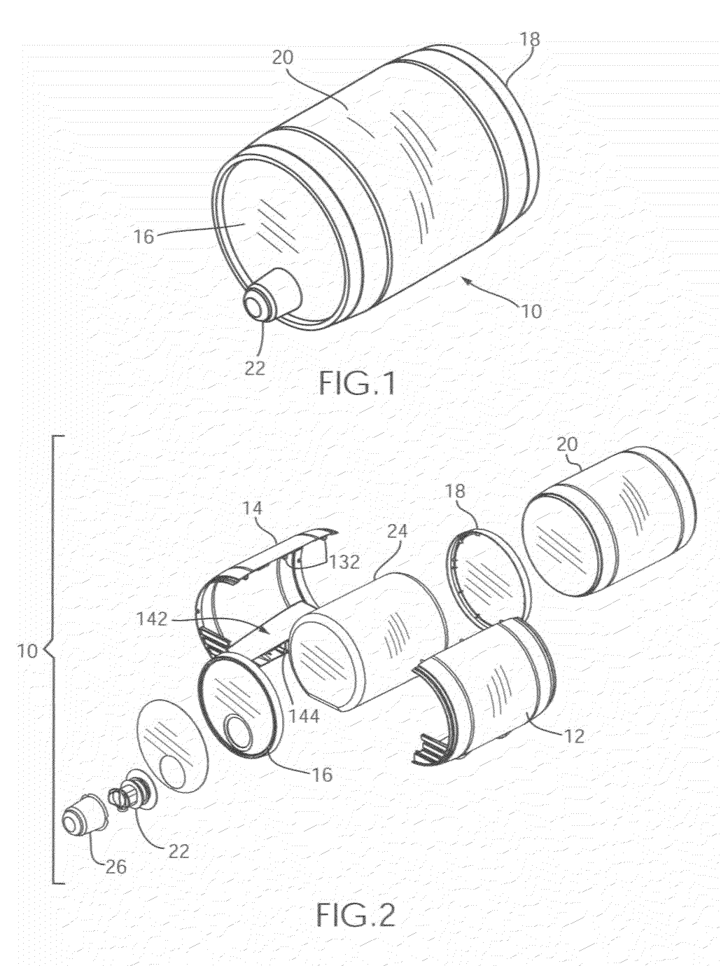

In accordance with the preferred embodiment of the present invention, a wine container and dispenser is shown in FIGS. 1-9c.

### 1. Detailed Description of the Figures.

Referring now to the drawings, and generally to FIG. 1-2, an improved wine container and dispenser system, generally noted as 10, is shown incorporating the teachings and improvements of the present invention. The container 10 forms an overall, generally cylindrical housing exemplarily formed of a left barrel half or first cylindrical casing 12 opposite a right barrel half or second cylindrical casing 14, and a front lid 16 opposite a rear lid 18. An outer sheath 20 circumscribes the assembled barrel body 16, 18, and a spout 22, in fluid communication with an internally stored, compressible fluid bladder 24. The spout 22 is protected by a spout cover 26 that is removably affixed to the front lid 16 as will be described in greater detail below.

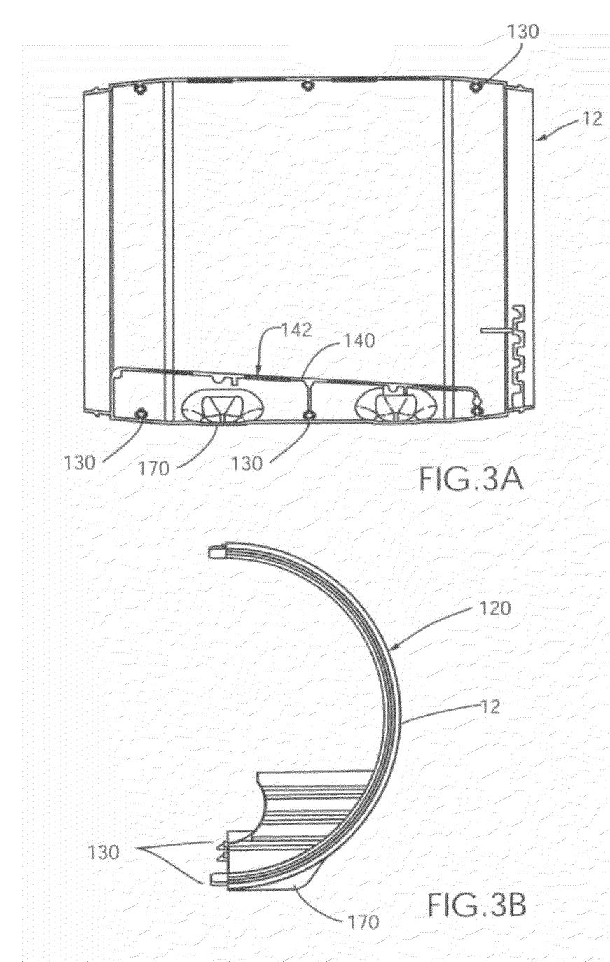

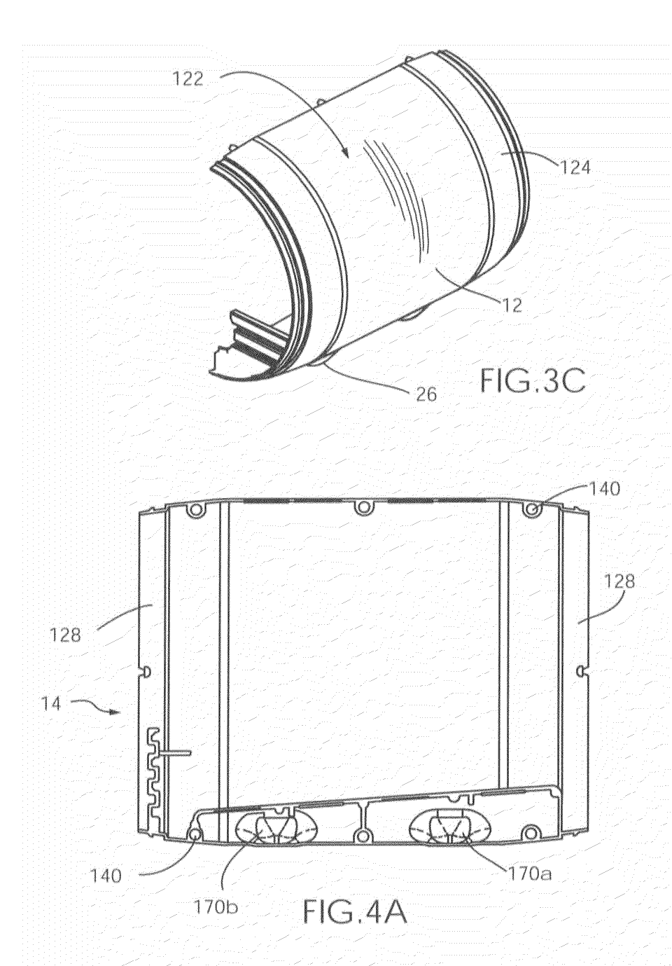

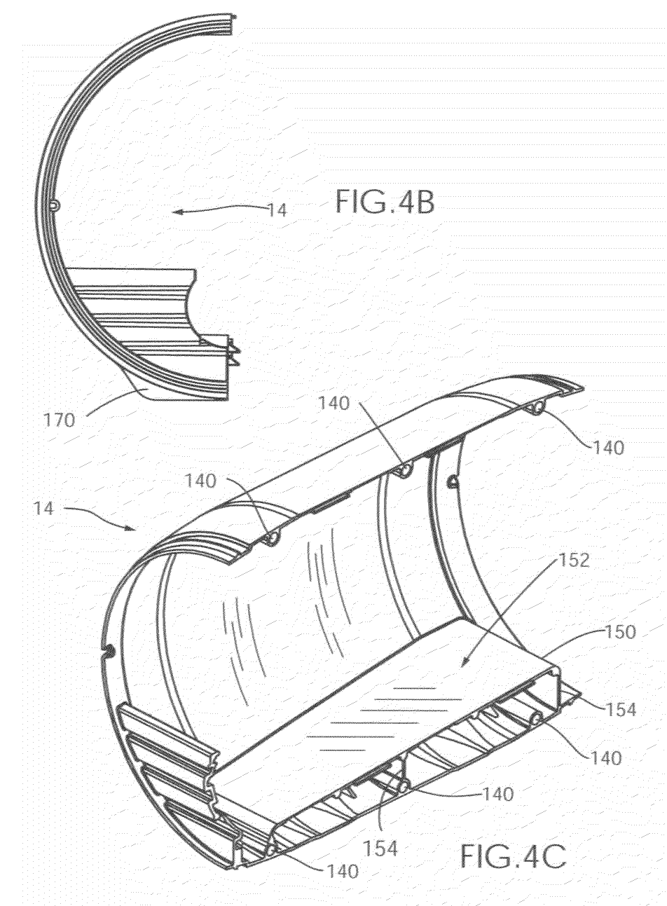

Referring now in conjunction with FIG. 3a-3c, the left barrel half 12 is shown in greater detail. While FIG. 4a-4c show similar view for the right barrel half 14, it would be reasonably taught to one skilled in the relevant art, given the present teachings, that the details of each half 12, 14 would be similar and cooperatively aligned for connection to a cylindrical barrel shaped housing, and as such for purposes of brevity a detailed recitation of those individual elements will be done only for those on one side of the assembly. Generally, the left barrel half 12 is anticipated of being formed of injection molded polypropylene to form a semi-cylindrical outer housing 120 having a constant radius about a center portion 122 and tapering slightly inward at a rear portion 124 and front portion 126. The outer housing 120 terminates along its end at a seam that cooperatively engages with the right barrel half 14 to form the seam along the axial centerline of the assembled cylinder. While it would be obvious to one of normal skill in the relevant art in conjunction with the present teachings that the cooperative engagement of the barrel halves 12, 14 can be accomplished in a variety of ways, it would thereby be understood that the in the preferred embodiment a series of extended protuberances 130 with aligning and relieving recesses 140 such as to form a snap fit connection could be equivalently replace with a variety of mechanical attachment means, adhesive attachment means or techniques for joining plastic parts. In the preferred embodiment of the present invention as shown, these mechanical fastening elements 130, 140 can be molded into the barrel halves 12, 14, but would be only suitable for strong enough plastics that could allow to joint to survive the strain of assembly, service load, and the like. Alternately, it is anticipated that mechanical fasteners (screws, rivets, pins, etc.), glued or welded connections may also be selected under various circumstances.

The lower portion of the barrel half 12 (and similarly, 14) forms a number of additional features of importance to the present teachings. A lower support platform 150 is shown molded into the inside bottom surface of the barrel half 12 and forms an angularly declined ramp surface 152 that has a flat upper surface 152 supported by a plurality of reinforcing supporting structures 154. The surface 152 is angled downward, relevant to gravitational level and horizontal centerline, toward the front lid 16 such as to support the bladder 24 such that the bladder contents maintain fluid communication with the spout 22 in a manner to prevent intrusion of air into the system when the spout 22 is opened to dispense the liquid contents. Such a hydraulic seal will maintain freshness of the liquid contents longer after an initial dispensing by preventing siphoning of air into the bladder and thereby preventing the mixing of air and liquid that causes the oxidation of the wine.

Opposite and aligned with the ramp surface 152 on the exterior lower portion of the barrel half 12 (and similarly, 14) an outwardly disposed flat portion 170 is formed on the arcuate circumference. The flat portion 170 is substantially smaller than the arcuate circumference of the cylindrical casing 12, 14. The primary function of the flat portion 170 is to provide a stabilized base to prevent the wine container and dispenser system 10 from rolling once placed on a flat horizontal surface. As shown in the preferred embodiment, the flat portion 170 is shown as a pair of laterally elongated rods 170a, 170b formed as an outward protrusion from the lower portions of each barrel half 12, 14.

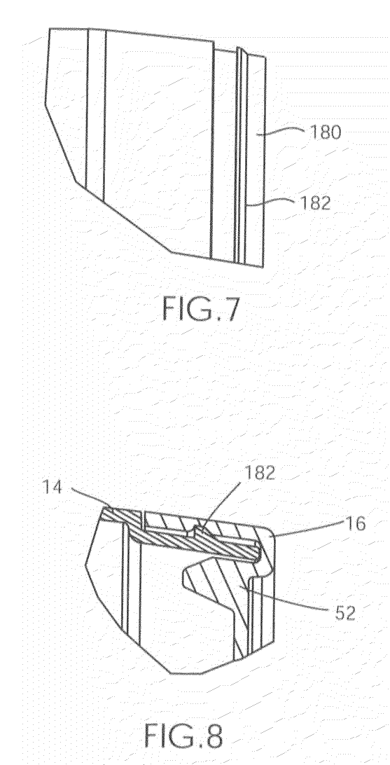

Terminating the tapered rear portion 124 and front portion 126 and extending outward from each tapered end of the cylindrical casing is an inwardly offset extension 180. As shown in conjunction with the exploded detail of FIG. 7, an outwardly disposed rib 182 circumscribes the outer surface of the extension 180 to allow for locking into the inside of a front lid 16 or rear lid 18 as will be described in greater detail below.

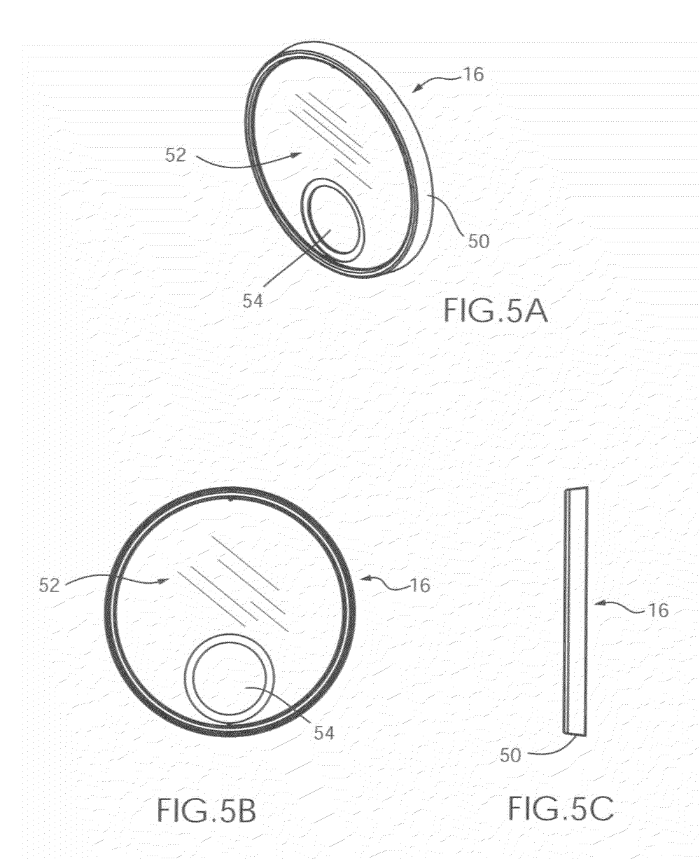

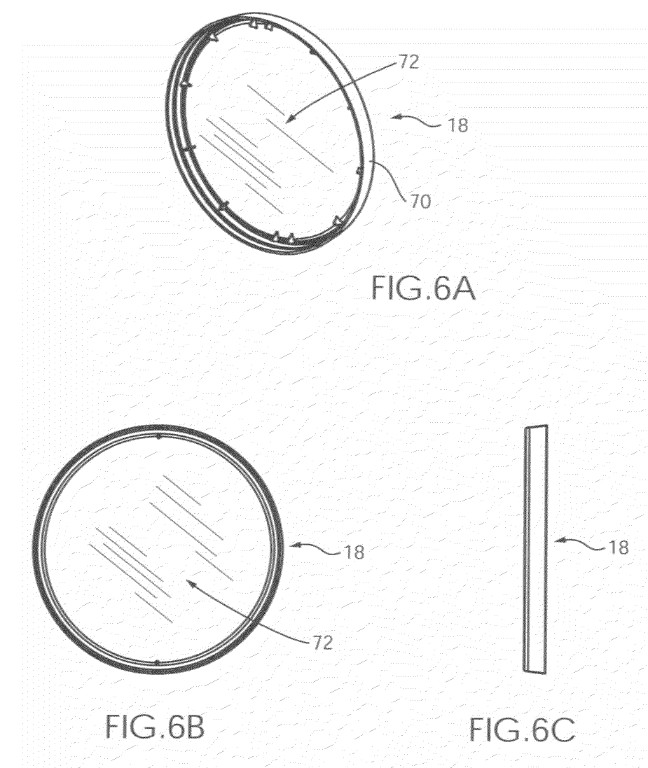

Referring now in conjunction with FIG. 5a-5c, the front lid 16 is shown in greater detail. A flanged outer periphery 50 circumscribes an outer face 52 that forms a spout orifice 54 is formed at the lower outer edge. In conjunction with FIG.6a-6c, the rear lid 18 shows a similar flanged outer periphery 60 that circumscribes a second outer face 62. About the inside circumference of the flanged first and second flanged outer periphery 50, 60 are a series of compression bosses 52 that extend rearward opposite the outer face 52, 62 respectively. As shown in greater detail in conjunction with FIG. 8, the flanged outer periphery 52, 62 respectively circumscribes the inwardly offset extension 180 that terminates the end of each tapered portion 126, 128 such that the outwardly disposed rib 182 engages lockingly with a mating groove 54. The compression bosses 52 thereby provide an outward urging force to cause impingement of the outwardly disposed rib 182 into the mating groove 54.

Finally, a flexible outer sheath 20 is shown in an exemplary embodiment as a shrink wrap polymeric film. This outer sheath 20 is placed around the assembled container 10 to provide two functions. The first is to provide an indicia supporting surface to allow for placement of branding material, printed logo or advertisement, and can work in conjunction with the overall container 10 to provide a unique brand differentiation. Secondly, this outer sheath 20 provides an inwardly tensioned securing force to the assembled barrel halves 12, 14 to provide an overall rigidity to the assembly for handling, shipping, and packing. Given the teachings of the present disclosure it may become apparent to one skilled in the relevant art that other methods of securing the outer sheath 20, such as through adhesives or fasteners, could also provide similar benefits and functionality.

### 2. Operation of the Preferred Embodiment

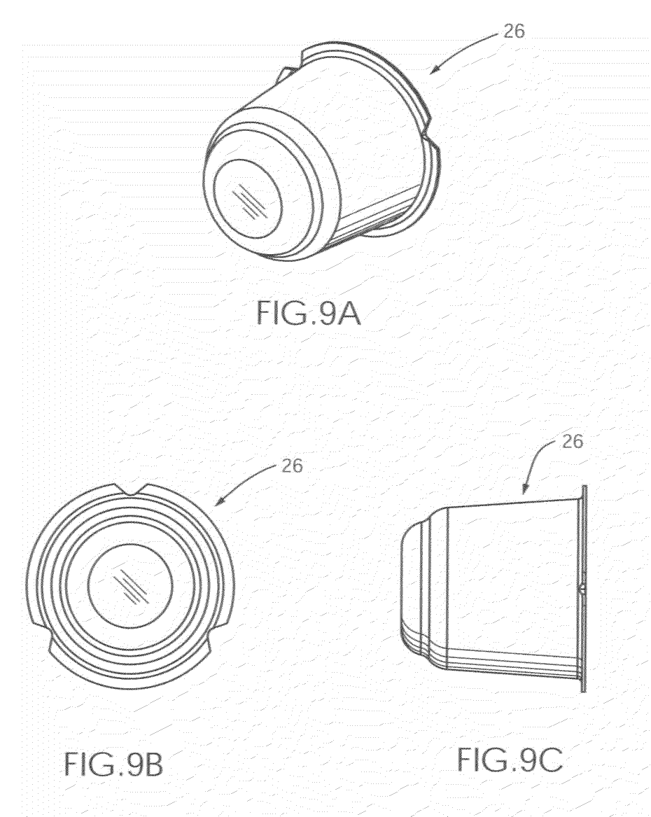

In operation, the container 10 is formed after the compressible fluid bladder 24 is filled with liquid. The bladder 24 is preferably flexible and manufactured from a polymeric material approved for use with beverages for human consumption. Preferably, the polymeric material is reusable and/or recyclable. The bladder 24 is substantially water-tight, and features a re-sealable pour spout 22 at one end. The pour spout 22 is user-controllable and is utilized to regulate the flow of wine out of the bladder 24. It is envisioned that the pour spout 22 is of conventional construction and may be selected from a variety of known re-sealable fluid dispensers. As shown best in conjunction with FIG. 9a-9c, the pour spout further features a reusable spout cover 26, which locks around the periphery of the pour spout 22 that is removably affixed to the front lid 16.

Once the fluid bladder 24 is provided filled with fluid, in the present matter wine, the bladder 4 is placed between left barrel half or first cylindrical casing 12 and the right barrel half or second cylindrical casing 14. The fluid bladder 24 is supported on the angularly declined ramp surface 152 such that the flat upper surface supports the bladder 24 such that the spout 22 is angled downward. The casing halves 12, 14 are engaged together, and the front lid 16 and rear lid 18 engaged to each respective end of the container 10. The outer sheath 20 is provided, pre-printed with desired indicia, and placed circumscribing the assembled barrel body. If utilizing a shrink wrappable polymeric film, the container 10 is then heated to the point where the sheath shrinks against and conforms to the outer surface of the container 10. However, as indicated above it is anticipated that this sheath 20 could be formed of a different material and, subsequently, attached to the container 10 in an appropriately different manner.

Once assembled, the containers 10 can be stored, stacked, packaged, shipped and displayed in an extremely efficient manner. The total volume of packing materials are minimized to safely and effectively transport a given volume of material. Once procured by the individual user, the container can be easily transported, and can be stored within or without a refrigerator with a minimum of needed space. The container 10 can then be placed on a level surface so that the flat portion 170 is abutting against the surface. The user then removes the spout cover 26 and dispenses product at selected volumes.

One of ordinary skill in the relevant art will appreciate that the present invention lends itself to use in a variety of applications. It should also be noted that the present invention does not preclude the utilization of beverages other than wine. It is anticipated that the present invention fits household and commercial wine storage and dispensing applications.

While the foregoing description of the present invention is shown as being anticipatory to the preferred embodiments, it is further envisioned that the present invention may be used in any situation where the application of a wine container and dispenser system may be suitable. The particular embodiments described herein are not intended to limit the scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

1. A wine container and dispenser comprising:
a substantially cylindrical casing,
a flexible and substantially water-tight beverage bag placed inside said casing,
a resealable pour spout associated with one end of said beverage bag, and
a slanted tray,
wherein said slanted tray is placed on the bottom of said casing and serves to support said beverage bag.

2. A wine container and dispenser according to claim 1, wherein the tray angles said beverage bag so its contents are directed toward said pour spout.

3. A wine container and dispenser according to claim 1, further comprising a protective sleeve dimensioned so that it securely envelops said casing.

4. An improved wine container and dispenser system comprising:
a container that forms an overall, generally cylindrical housing formed of a left barrel half or first cylindrical casing opposite a right barrel half or second cylindrical casing, and a front lid opposite a rear lid;
a spout, in fluid communication with an internally stored, compressible fluid bladder; and
a tray positioned inside said container so that it slants toward an opening which accommodates a pour spout, wherein a sloping profile of said tray facilitates the dispensing of the entire contents without having to tilt the wine container and dispenser system.

5. The improved wine container and dispenser system of claim 4, further comprising:
an outer sheath circumscribing said the assembled barrel body and providing an inwardly tensioned securing force to the assembled barrel halves to provide an overall rigidity to the assembly for handling, shipping, and packing.

6. The improved wine container and dispenser system of claim 5, wherein said outer sheath further provides an indicia supporting surface to allow for placement of branding material, printed logo or advertisement, that visually communicate in conjunction with the overall container to provide a unique brand differentiation.

7. The improved wine container and dispenser system of claim 4, wherein:
said left barrel half and said right barrel half cooperatively align for connection together to form a cylindrical barrel shaped housing;
said left barrel half is formed of injection molded plastic to form a semi-cylindrical outer housing having a constant radius about a center portion and tapering slightly inward at a rear portion and front portion, said outer housing terminates along its end at a seam that cooperatively engages with the right barrel half to form the seam along the axial centerline of the assembled cylinder; and
said right barrel half is formed of injection molded plastic to form a semi-cylindrical outer housing having a constant radius about a center portion and tapering slightly inward at a rear portion and front portion, said outer housing terminates along its end at a seam that cooperatively engages with the left barrel half to form the seam along the axial centerline of the assembled cylinder;
wherein a series of extended protuberances along one barrel half aligning with a series of recesses formed along said other barrel half such as to form a snap fit connection therebetween.

8. The improved wine container and dispenser system of claim 4, wherein a lower portion of each said barrel half respectively forms a lower support platform molded into the inside bottom surface of said barrel halves and forms an angularly declined ramp surface that has a flat upper surface supported by a plurality of reinforcing supporting structures, said surface angled downward, relevant to gravitational level and horizontal centerline, toward said front lid such as to support said bladder such that the bladder contents maintain fluid communication with said spout in a manner to prevent intrusion of air into the system when the spout is opened to dispense the liquid contents.

9. The improved wine container and dispenser system of claim 8, wherein opposite and aligned with said ramp surface on the exterior lower portion of the barrel halves is formed an outwardly disposed flat portion formed on the arcuate circumference such that said flat portion is substantially smaller than the arcuate circumference of the cylindrical casing, whereby said flat portion provides a stabilized base to prevent the wine container and dispenser system from rolling once placed on a fiat horizontal surface.

10. The improved wine container and dispenser system of claim 7, wherein:
terminating a tapered rear portion and front portion and extending outward from each tapered end of the is an inwardly offset extension; and
an outwardly disposed rib circumscribes an outer surface of the extension to allow for locking into the inside of a front lid or a rear lid to said front portion or rear portion respectively.

11. The improved wine container and dispenser system of claim 5, wherein said flexible outer sheath is a heat shrinkable polymeric film.

12. A method for packaging, shipping and dispensing a compressible fluid bladder filled with wine, wherein said bladder is flexible and manufactured from a polymeric material approved for use with beverages for human consumption and is substantially water-tight, and features a re-sealable pour spout at one end, said pour spout being user-controllable and is utilized to regulate the flow of wine out of the bladder, said method comprising the steps:
a. provided said bladder filled with wine;
b. placing said bladder between a left barrel half or first cylindrical casing and a right barrel half or second cylindrical casing, whereby said fluid bladder is supported on an angularly declined ramp surface formed within said left and right barrel halves such that said flat upper surface supports said bladder such that the spout is angled downward;
c. engaging said casing halves together to form a generally cylindrical housing and connecting a front lid and a rear lid to engaged to each respective end of said cylindrical housing;
d. circumscribing said cylindrical housing with an outer sheath;
wherein said outer sheath circumscribing said the assembled barrel body provides an inwardly tensioned securing force to the assembled barrel halves to provide an overall rigidity to the assembly for handling, shipping, and packing.

13. The method of claim 12, wherein said shealth is pre-printed with desired indicia,

14. The method of claim 12, wherein said outer sheath is a shrink wrappable polymeric film, and wherein said method comprising the further step of heating said polymeric film to the point where the sheath shrinks against and conforms to the outer surface of the container.

15. The method of claim 12, further comprising the step of placing said on a level surface so that a flat portion is abutting against the surface whereby said flat portion provides a stabilized base to prevent the wine container and dispenser system from rolling once placed on a flat horizontal surface.
